(19) United States
(12) Patent Application Publication
(10) Pub. No.: US 2025/0310964 A1
(43) Pub. Date: Oct. 2, 2025

(54) PDCCH MONITORING IN CARRIER AGGREGATION DEPLOYMENT

(71) Applicant: Nokia Technologies Oy, Espoo (FI)

(72) Inventors: Chunli WU, Beijing (CN); Timo KOSKELA, Oulu (FI); Jorma Johannes KAIKKONEN, Oulu (FI)

(21) Appl. No.: 18/841,619

(22) PCT Filed: Feb. 28, 2022
(86) PCT No.: PCT/CN2022/078444

§ 371 Date: Aug. 26, 2024

(51) Int. Cl. H04W 72/23; H04W 28/02; H04W 72/1263

(52) U.S. Cl. CPC H04W 72/23; H04W 28/0278; H04W 72/1263

(57) ABSTRACT

Example embodiments of the present disclosure relate to devices, methods, apparatuses and computer readable storage media for PDCCH monitoring in carrier aggregation deployment. In example embodiments, a first device determines, during a physical downlink control channel monitoring adaptation, to transmit a scheduling request to a second device. Then, the first device transmits the scheduling request to the second device. Moreover, the first device determines one or more cells on which the physical downlink control channel monitoring is to be performed. Then, the first device performs the physical downlink control channel monitoring on the one or more cells.

### FIELD

Example embodiments of the present disclosure generally relate to the field of communications, and in particular, to devices, methods, apparatuses and computer readable storage media for physical downlink control channel (PDCCH) monitoring in carrier aggregation deployment.

### BACKGROUND

In the third Generation Partnership Projection (3GPP) standardization for New Radio (NR), power saving of user equipment (UE) is a big concern. There are enhancements on power saving techniques. For example, one of downlink control information (DCI) based technologies for active time power saving considered in power saving is PDCCH monitoring adaptation. The PDCCH monitoring adaptation comprises search space set group (SSSG) switching and PDCCH skipping. In the SSSG switching, the configured search space (SS) sets can be assigned to groups, where one group can be activated based on DCI indication and/or timer, so that the UE monitors PDCCH in the SS set belonging to an active group. In the PDCCH skipping, the UE can be indicated based on DCI to stop PDCCH monitoring for a configured duration.

However, during the PDCCH monitoring adaptation, the UE may determine to transmit a scheduling request to a network device, for example if there is a buffer status report to be transmitted to the network device, or there is occurrence of beam failure recovery or a failure of a listen before talk (LBT) procedure. Then, the network device may transmit a grant as a response to the scheduling request. Although any of the serving cells can be used to transmit the grant, it may not be beneficial for the UE to perform the PDCCH monitoring on all the cells for example from UE power consumption perspective. Therefore, among others open issues, how to determine which one or more cells to be performed PDCCH monitoring is still an open issue be addressed.

### SUMMARY

In general, example embodiments of the present disclosure provide devices, methods, apparatuses and computer readable storage media for PDCCH monitoring in carrier aggregation deployment.

In a first aspect, a method is provided. In the method, a first device determines, during a physical downlink control channel monitoring adaptation, to transmit a scheduling request to a second device. Then, the first device transmits the scheduling request to the second device. Moreover, the first device determines one or more cells on which the physical downlink control channel monitoring is to be performed. Then, the first device performs the physical downlink control channel monitoring on the one or more cells.

In a second aspect, a method is provided. In the method, a second device receives, from a first device, a scheduling request during a physical downlink control channel monitoring adaptation for the first device. Then, the second device determines a cell to transmit, to the first device, a grant for the scheduling request. Moreover, the second device transmits the grant on the cell to the first device, regardless the physical downlink control channel monitoring adaptation.

In a third aspect, a first device is provided which comprises at least one processor and at least one memory including computer program code. The at least one memory and the computer program code are configured to, with the at least one processor, cause the first device to determine, during a physical downlink control channel monitoring adaptation, to transmit a scheduling request to a second device. Then, the first device is caused to transmit the scheduling request to the second device. Moreover, the first device is caused to determine one or more cells on which the physical downlink control channel monitoring is to be performed. Then, the first device is caused to perform the physical downlink control channel monitoring on the one or more cells.

In a fourth aspect, a second device is provided which comprises at least one processor and at least one memory including computer program code. The at least one memory and the computer program code are configured to, with the at least one processor, cause the second device to receive, from a first device, a scheduling request during a physical downlink control channel monitoring adaptation for the first device. Then, the second device is caused to determine a cell to transmit, to the first device, a grant for the scheduling request. Moreover, the second device is caused to transmit the grant on the cell to the first device, regardless the physical downlink control channel monitoring adaptation.

In a fifth aspect, there is provided an apparatus comprising means for performing the method according to the first aspect or the second aspect.

In a sixth aspect, there is provided a computer readable storage medium comprising program instructions stored thereon. The instructions, when executed by a processor of a device, cause the device to perform the method according to the first aspect or the second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the first device and the second device according to some example embodiments of the present disclosure;

FIG. 3 illustrates a flowchart of an example method according to some example embodiments of the present disclosure;

FIG. 4 illustrates a flowchart of an example method according to some other example embodiments of the present disclosure; and

FIG. 5 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

As described above, in the 3GPP standardization, there are some discussions about enhancements on power saving techniques. For example, one of downlink control information (DCI) based technologies for active time power saving considered in power saving is PDCCH monitoring adaptation. The PDCCH monitoring adaptation comprises search space set group (SSSG) switching and PDCCH skipping. In the SSSG switching, the configured search space (SS) sets can be assigned to groups, where one group can be activated based on DCI indication and/or timer, so that the UE monitors PDCCH in the SS set belonging to an active group. In the PDCCH skipping, the UE can be indicated based on the DCI to stop PDCCH monitoring for a configured duration. In some examples, the PDCCH monitoring adaptation may refer to PDCCH monitoring relaxation e.g. UE may be required to monitor PDCCH less frequently, not required to monitor PDCCH for a time duration or monitor PDCCH using alternative/adapted configuration.

A scheduling request is used for requesting uplink (UL) shared channel resources for new transmission. For example, the MAC entity may be configured with zero, one, or more scheduling request configurations. A scheduling request configuration consists of a set of PUCCH resources for the scheduling request across different bandwidth parts (BWPs) and cells. For a logical channel or for beam failure recovery or for LBT failure recovery, at most one PUCCH resource for the scheduling request may be configured per BWP.

However, it may occur that the UE may determine to transmit a scheduling request to a network device during the PDCCH monitoring adaptation, for example if there is a buffer status report to be transmitted to the network device, or there is occurrence of beam failure recovery or a failure of a listen before talk procedure. In this case, the scheduling request configuration is determined for SR transmission corresponds to one or more logical channels and/or to beam failure recovery and/or to LBT failure recovery. That is, each logical channel, beam failure recovery, and LBT failure recovery may be mapped to zero or one scheduling request configuration, which is configured by radio resource control (RRC). The scheduling request configuration of the logical channel that triggered the buffer status report or the beam failure recovery or the LBT failure recovery (if such a configuration exists) is considered as corresponding scheduling request configuration for the triggered scheduling request.

Then, the network device may transmit a grant as a response to the scheduling request. Although any of the serving cells can be used to transmit the grant, it may not be beneficial for the UE to perform the PDCCH monitoring on all the cells for example from UE power consumption perspective.

Thus, there is a need to determine that which one or more cells will be performed PDCCH monitoring at the UE side. Besides, by now, there is no effective way to determine the one or more cells to be performed PDCCH monitoring to further improve communication efficiency.

Example embodiments of the present disclosure provide a scheme of PDCCH monitoring in carrier aggregation deployment. With the scheme, a device (referred to as a first device), such as a UE, determines, during a PHCCH monitoring adaptation, to transmit a scheduling request to another device (referred to as a second device), such as a base station. Then, the first device transmits the scheduling request to the second device. In addition, the first device determines one or more cells on which the PDCCH monitoring is to be performed. Then, the first device performs the PDCCH monitoring on the one or more cells.

This scheme facilitate PDCCH monitoring flexibly and efficiently by performing the PDCCH monitoring only on one or more determined cells, instead of all serving cells. As such, it is allowed to avoid unnecessary signaling overhead and power consumption.

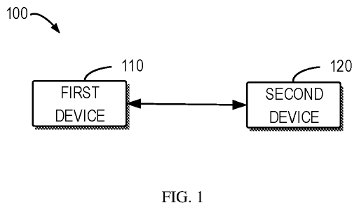

FIG. 1 shows an example environment 100 in which example embodiments of the present disclosure can be implemented.

The environment 100, which may be apart of a communication network, comprises two devices 110 and 120 communicating with each other or with other devices via each other. For the purpose of discussion, the devices 110 and 120 may be referred to as a first device 110 and a second device 120, respectively.

The first and second devices 110 and 120 may be implemented by any suitable devices in the communication network. In some example embodiments, the first device 110 may be implemented by a terminal device and the second device 120 may be implemented by a network device, or vice versa. In some other example embodiments, the first and second devices 110 and 120 may be both implemented by terminal devices or network devices. Just for the purpose of discussion, in this example, the terminal device will be taken as an example of the first device 110, and the network device will be taken as an example of the second device 120.

It is to be understood that two devices are shown in the environment 100 only for the purpose of illustration, without suggesting any limitation to the scope of the present disclosure. In some example embodiments, the environment 100 may comprise a further device to communicate with the first device 110 and the second device 120.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

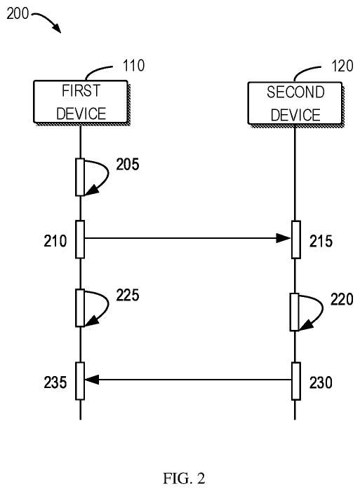

FIG. 2 shows a signaling flow 200 between the first device 110 and the second device 120 according to some example embodiments of the present disclosure. For the purpose of discussion, the signaling flow 200 will be described with reference to FIG. 1.

In some example embodiments, the first device 110 may receive from the second device 120 a command to perform a PDCCH monitoring adaptation. For example, the first device 110 may receive a command from the second device 120 to perform PDCCH monitoring with a configured periodicity. Alternatively, the first device 110 may receive a command to stop PDCCH monitoring for a configured duration.

As shown in FIG. 2, the first device 110 determines (205), during a PDCCH monitoring adaptation, to transmit a scheduling request to the second device 120. In this case, the first device 110 may ignore the command from the second device 120 to perform the PDCCH monitoring adaptation, that is, to stop the performance of the PDCCH monitoring adaptation, and start PDCCH monitoring for one or more cells.

In some example embodiments, the first device 110 may, in response to a buffer status report to be transmitted to the second device 120, determine to transmit, to the second device 120, the scheduling request for the buffer status report. Alternatively, the first device 110 may, in response to occurrence of beam failure recovery, determine to transmit, to the second device 120, the scheduling request for the beam failure recovery. Alternatively, the first device 110 may, in response to a failure of a listen before talk procedure, determine to transmit, to the second device 120, the scheduling request for the failure of the listen before talk procedure.

Then, the first device 110 transmits (210) the scheduling request to the second device 120. Accordingly, the second device 120 receives (215), from the first device 110, the scheduling request during the PDCCH adaptation for the first device 110. In some example embodiments, the second device 120 may receive a scheduling request for a buffer status report during the PDCCH monitoring adaptation. Alternatively, the first device 110 may receive a scheduling request for beam failure recovery during the PDCCH monitoring adaptation. Alternatively, the first device 110 may receive a scheduling request for a failure of a listen before talk procedure during the PDCCH monitoring adaptation.

As shown in FIG. 2, the second device 120 determines (220) a cell to transmit, to the first device 110, a grant for the scheduling request. The second device 120 may first determines at least one cell available to the transmission of the grant. Then, the second device may determine the cell to transmit the grant by selecting one from the determined at least one available cell.

In the example embodiments where the scheduling request is for the buffer status report, the second device 120 may determine the cell to transmit the grant for the scheduling request based on the identifier of the scheduling request, for the reason that in this case, the identifier of the scheduling request may be associated with one or more logical channels, and thus associated with an allowed cell list, for example, a parameter called allowedServingCells.

For example, Logical channel configuration information element may be shown below. The configuration may restrict UL media access control (MAC) service data unit (SDU) of certain logical channel transmission to specific serving cells. This is controlled by the allowedServingCells parameter. The UL MAC SDUs from this logical channel may only be mapped to the serving cells indicated in this allowedServingCells parameter. When an identifier of a scheduling request is associated to a specific logical channel, the scheduling request may be triggered for requesting UL resources for transmission of buffer status report triggered by the specific logical channel. For example, one logical channel may be associated with an identifier of a scheduling request. As another example, a plurality of logical channels may be associated with the same identifier of a scheduling request.

LogicalChannelConfig information element

-- ASN1START
-- TAG-LOGICALCHANNELCONFIG-START

| | |
|---|---|
| LogicalChannelConfig ::= | SEQUENCE { |
| ul-SpecificParameters | SEQUENCE { |
| priority | INTEGER (1..16), |
| prioritisedBitRate | ENUMERATED {kBps0, kBps8, kBps16, kBps32, kBps64, kBps128, kBps256, |

kBps512,

kBps1024, kBps2048, kBps4096, kBps8192, kBps16384, kBps32768,

kBps65536, infinity},

| | |
|---|---|
| bucketSizeDuration | ENUMERATED {ms5, ms10, ms20, ms50, ms100, ms150, ms300, ms500, |

ms1000,

| | |
|---|---|
| | spare7, spare6, spare5, spare4, spare3, spare2, spare1}, |
| allowedServingCells | SEQUENCE (SIZE (1..maxNrofServingCells-1)) OF ServCellIndex |

OPTIONAL, -- PDCP-CADuplication

| | |
|---|---|
| allowedSCS-List | SEQUENCE (SIZE (1..maxSCSs)) OF SubcarrierSpacing |

OPTIONAL, -- Need R

| | |
|---|---|
| maxPUSCH-Duration | ENUMERATED {ms0p02, ms0p04, ms0p0625, ms0p125, ms0p25, |

ms0p5, spare2, spare1}
OPTIONAL, -- Need R

| | |
|---|---|
| configuredGrantType1Allowed | ENUMERATED {true} |

OPTIONAL, -- Need R

| | |
|---|---|
| logicalChannelGroup | INTEGER (0..maxLCG-ID) |

OPTIONAL, -- Need R

| | |
|---|---|
| schedulingRequestID | SchedulingRequestld |

OPTIONAL, -- Need R

| | |
|---|---|
| logicalChannelSR-Mask | BOOLEAN, |

```
    logicalChannelSR-DelayTimerApplied BOOLEAN,
    ...,
```

| | |
|---|---|
| bitRateQueryProhibitTimer | ENUMERATED {s0, s0dot4, s0dot8, s1dot6, s3, s6, s12, s30} |

OPTIONAL, -- Need R
[[

| | |
|---|---|
| allowedCG-List-r16 | SEQUENCE (SIZE (0.. maxNrofConfiguredGrantConfigMAC-r16-1)) OF |

ConfiguredGrantConfigIndexMAC-r16
OPTIONAL, -- Need S

| | |
|---|---|
| allowedPHY-PriorityIndex-r16 | ENUMERATED {p0, p1} |

```
OPTIONAL -- Need S
    ]]
  }
OPTIONAL, -- Cond UL
  ...,
  [[
```

| | |
|---|---|
| channelAccessPriority-r16 | INTEGER (1..4) |

OPTIONAL, -- Need R

| | |
|---|---|
| bitRateMultiplier-r16 | ENUMERATED {x40, x70, x100, x200} |

OPTIONAL -- Need R
]]
}
-- TAG-LOGICALCHANNELCONFIG-STOP
-- ASN1STOP

In the example embodiments where the scheduling request is for the buffer status report and one logical channel is associated with an identifier of the scheduling request, the second device 120 may determine, based on the identifier of the scheduling request, a cell in an allowed cell list associated with the one logical channel associated with the identifier of the scheduling request to transmit the grant. For example, the second device 120 may determine, based on the identifier of the scheduling request, at least one available cell in an allowed cell list associated with the one logical channel. Then, the second device 120 may select one from the determined at least one available cell, and use the selected cell to transmit the grant. In this case, the determined cell in the allowed cell list may comprise a cell with a lowest cell index in the allowed cell list. Alternatively, the determined cell in the allowed cell list may comprise a cell with a highest cell index in the allowed cell list. Alternatively, the determined cell may comprise a cell with configured cell index or set of cell index. This configuration may be provided by the second device 120.

In the example embodiments where the scheduling request is for the buffer status report and one logical channel is associated with an identifier of the scheduling request, the second device 120 may transmit, to the first device 110, information of at least one cell index. Then, the second device 120 may determine at least one cell with the at least one cell index in an allowed cell list associated with the one logical channel. Then, the second device 120 may select one from the determined at least one cell, and use the selected cell to transmit the grant.

In the example embodiments where the scheduling request is for the buffer status report and a plurality of logical channels are associated with an identifier of the scheduling request, the second device 120 may determine, based on the identifier of the scheduling request, a cell in a plurality of allowed cell lists associated with the plurality of logical channels to transmit the grant. For example, the second device 120 may determine, based on the identifier of the scheduling request, at least one available cell in the plurality of allowed cell lists associated with the plurality of logical channels. Then, the second device 120 may select one from the determined at least one available cell, and use the selected cell to transmit the grant. In this case, the determined cell in the plurality of allowed cell lists may comprise a cell with a lowest cell index in the plurality of allowed cell lists. Alternatively, the determined cell in the plurality of allowed cell lists may comprise a cell with a highest cell index in the plurality of allowed cell lists.

In some example embodiments, the second device 120 may transmit, to the first device 110, an indication of at least one cell associated with the identifier of the scheduling request. Then, for example, the second device 120 may determine at least one cell available to the transmission of the grant based on the identifier of the scheduling request. Then, the second device 120 may select one from the determined at least one available cell, and use the selected cell to transmit the grant.

In some example embodiments, if dual connectivity is enabled, the second device 120 may determine a primary cell for a master cell group to transmit the grant. Alternatively, the second device 120 may determine a primary secondary cell for a secondary cell group to transmit the grant.

In some example embodiments, if dual connectivity is enabled, the second device 120 may determine a cell group to which the cell where the scheduling request is transmitted belongs. Then, the second device 120 may determine a cell in the cell group to transmit the grant.

In some example embodiments, if the identifier of the scheduling request for beam failure recovery or a failure of a LBT procedure is the same as the identifier of the scheduling request for buffer status report, the second device 120 may determine at least one cell available to the transmission of the grant based on union of the one or more cells determined for each scheduling request. Then, the second device 120 may select one from the determined at least one available cell, and use the selected cell to transmit the grant. Alternatively, if dual connectivity is enabled, the second device 120 may determine a primary cell for a master cell group or primary secondary cell for a secondary cell group to transmit the grant.

As shown in FIG. 2, accordingly, the first device 110 determines (225) one or more cells on which the PDCCH monitoring is to be performed.

Likewise, in the example embodiments where the scheduling request is for the buffer status report and one logical channel is associated with an identifier of the scheduling request, the first device 110 may determine, based on the identifier of the scheduling request, the one or more cells in an allowed cell list associated with the one logical channel as the one or more cells to be performed PDCCH monitoring. In this case, the determined one or more cells in the allowed cell list may comprise a cell with a lowest cell index in the allowed cell list and/or a cell with a highest cell index in the allowed cell list. Alternatively, the determined one or more cells in the allowed cell list may comprise all cells in the allowed cell list.

In the example embodiments where the scheduling request is for the buffer status report and one logical channel is associated with an identifier of the scheduling request, the first device 110 may receive information of at least one cell index from the second device 120. Then, the first device 110 may determine at least one cell with the at least one cell index in an allowed cell list associated with the one logical channel as the cell to be performed PDCCH monitoring.

In the example embodiments where the scheduling request is for the buffer status report and a plurality of logical channels are associated with an identifier of the scheduling request, the first device 110 may determine, based on the identifier of the scheduling request, one or more cells in a plurality of allowed cell lists associated with the plurality of logical channels as the one or more cells to be performed PDCCH monitoring. In this case, the determined one or more cells in the plurality of allowed cell lists may comprise a cell with a lowest cell index in the plurality of allowed cell lists and/or a cell with a highest cell index in the plurality of allowed cell lists. Alternatively, the determined one or more cells in the plurality of allowed cell lists may comprise all cells in the plurality of allowed cell lists.

In the example embodiments where the second device 120 transmits to the first device 110 an indication of at least one cell associated with the identifier of the scheduling request, the first device 110 may receive the indication of at least one cell associated with the identifier of the scheduling request. In this case, the first device 110 may determine the one or more cells of the at least one cell on which the physical downlink control channel monitoring is to be performed to be performed PDCCH monitoring based on the identifier of the scheduling request and the association.

In some example embodiments, if dual connectivity is enabled, the first device 110 may determine a primary cell for a master cell group to be performed PDCCH monitoring. Alternatively, the first device 110 may determine a primary secondary cell for a secondary cell group to be performed PDCCH monitoring.

In some example embodiments, if dual connectivity is enabled, the first device 110 may determine all of one or more cells in a cell group to which the cell where the scheduling request is transmitted belongs to transmit the grant as the one or cells to be performed PDCCH monitoring.

In some example embodiments, if the identifier of the scheduling request for beam failure recovery or a failure of a LBT procedure is the same as the identifier of the scheduling request for buffer status report, the first device 110 may determine the one or more cells to perform PDCCH monitoring based on union of the one or more cells determined for each scheduling request. Alternatively, if dual connectivity is enabled, the first device 110 may determine a primary cell for a master cell group or primary secondary cell for a secondary cell group to perform PDCCH monitoring.

As shown in FIG. 2, the second device 120 transmits (230) the grant on the determined cell to the first device 110, regardless the physical downlink control channel monitoring adaptation. Accordingly, the first device 110 performs (235) the physical downlink control channel monitoring on the determined one or more cells.

As such, by performing the PDCCH monitoring only on one or more determined cells, instead of all serving cells, it is allowed to avoid unnecessary signaling overhead and power consumption.

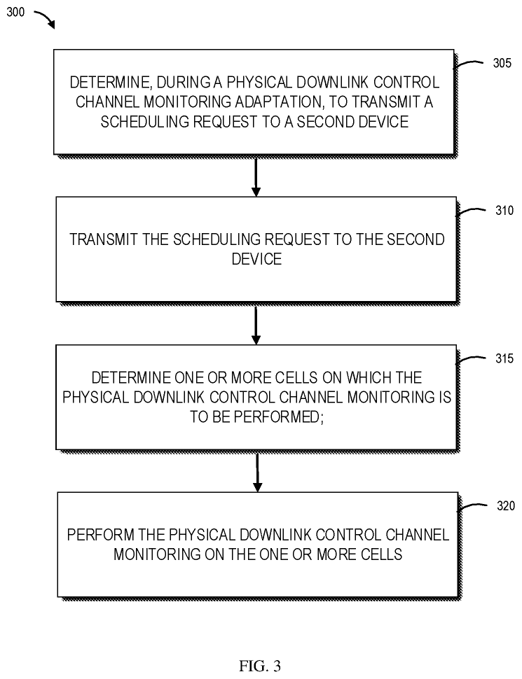

FIG. 3 shows a flowchart of an example method 300 according to some example embodiments of the present disclosure. The method 300 can be implemented at the first device 110 as shown in FIG. 1. For the purpose of discussion, the method 300 will be described with reference to FIG. 1.

At block 305, the first device 110 determines, during a physical downlink control channel monitoring adaptation, to transmit a scheduling request to the second device 120. Then, at block 310, the first device 110 transmits the scheduling request to the second device 120. Moreover, at block 315, the first device 110 determines one or more cells on which the physical downlink control channel monitoring is to be performed. Then, at block 320, the first device 110 performs the physical downlink control channel monitoring on the one or more cells.

In some example embodiments, the first device 110 may, in response to a buffer status report to be transmitted to the second device 120, determine to transmit, to the second device 120, the scheduling request for the buffer status report.

In some example embodiments, one logical channel may be associated with an identifier of the scheduling request, and the first device 110 may determine, based on the identifier of the scheduling request, the one or more cells in an allowed cell list associated with the one logical channel.

In some example embodiments, the determined the one or more cells in the allowed cell list may comprise at least one of: a cell with a lowest cell index in the allowed cell list; a cell with a highest cell index in the allowed cell list; or all cells in the allowed cell list.

In some example embodiments, one logical channel may be associated with an identifier of the scheduling request, and the first device 110 may receive, from the second device 120 information of at least one cell index; and determine at least one cell with the at least one cell index in an allowed cell list associated with the one logical channel.

In some example embodiments, a plurality of logical channels may be associated with an identifier of the scheduling request, and the first device 110 may determine, based on the identifier of the scheduling request, one or more cells in a plurality of allowed cell lists associated with the plurality of logical channels.

In some example embodiments, the determined the one or more cells in the plurality of allowed cell lists may comprise at least one of: a cell with a lowest cell index in the plurality of allowed cell lists; a cell with a highest cell index in the plurality of allowed cell lists; or all cells in the plurality of allowed cell lists.

In some example embodiments, the first device may, in response to occurrence of beam failure recovery, determine to transmit the scheduling request to the second device 120.

In some example embodiments, the first device 110 may, in response to a failure of a listen before talk procedure, determine to transmit the scheduling request.

In some example embodiments, the first device 110 may receive, from the second device 120, an indication of at least one cell associated with an identifier of the scheduling request. Further, the first device 110 may determine the one or more cells of the at least one cell on which the physical downlink control channel monitoring is to be performed based on the identifier of the scheduling request and the association.

In some example embodiments, the first device 110 may determine at least one of a primary cell for a master cell group or determine a primary secondary cell for a secondary cell group.

In some example embodiments, dual connectivity is enabled, and the first device 110 may determine all of one or more cells in a cell group to which the cell where the scheduling request is transmitted belongs.

In some example embodiments, the physical downlink control channel monitoring adaptation may comprise at least one of search space set group switching or physical downlink control channel skipping.

Those skilled in the art can understand that all operations and features as described above with reference to FIGS. 1-2 are likewise applicable to the method 300 and have similar effects.

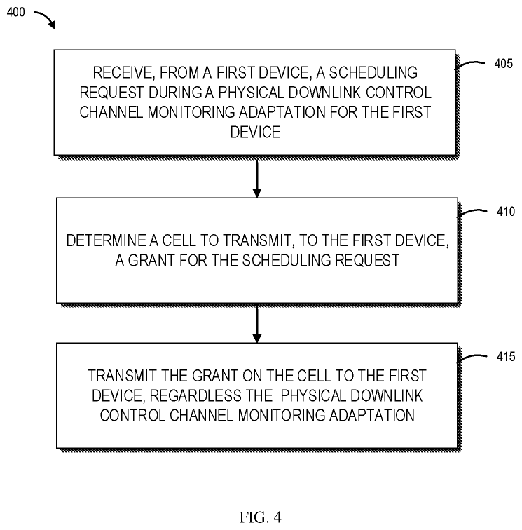

FIG. 4 shows a flowchart of an example method 400 according to some other example embodiments of the present disclosure. The method 400 can be implemented at the second device 120 as shown in FIG. 1. For the purpose of discussion, the method 400 will be described with reference to FIG. 1.

At block 405, the second device 120 receives, from the first device 110, a scheduling request during a physical downlink control channel monitoring adaptation for the first device 110. At block 410, the second device 120 determines a cell to transmit, to the first device 110, a grant for the scheduling request. Then, at block 415, the second device 120 transmits the grant on the cell to the first device 110, regardless the physical downlink control channel monitoring adaptation.

In some example embodiments, the second device 120 may receive a scheduling request for a buffer status report during the physical downlink control channel monitoring adaptation.

In some example embodiments, one logical channel may be associated with an identifier of the scheduling request, and the second device 120 may determine, based on the identifier of the scheduling request, a cell in an allowed cell list associated with the one logical channel to transmit the grant.

In some example embodiments, the determined cell in the allowed cell list may comprise one of: a cell with a lowest cell index in the allowed cell list; or a cell with a highest cell index in the allowed cell list.

In some example embodiments, one logical channel may be associated with an identifier of the scheduling request, and the second device 120 may transmit, to the first device 110, information of at least one cell index; and determine a cell of at least one cell with the at least one cell index in an allowed cell list associated with the one logical channel.

In some example embodiments, a plurality of logical channels may be associated with an identifier of the scheduling request, and wherein the second device 120 may determine, based on the identifier of the scheduling request, a cell in a plurality of allowed cell lists associated with the plurality of logical channels to transmit the grant.

In some example embodiments, the determined cell in the plurality of allowed cell lists may comprise one of: a cell with a lowest cell index in the plurality of allowed cell lists; or a cell with a highest cell index in the plurality of allowed cell lists.

In some example embodiments, the second device 120 may receive the scheduling request for beam failure recovery during the physical downlink control channel monitoring adaptation.

In some example embodiments, the second device 120 may receive the scheduling request for a failure of a listen before talk procedure during the physical downlink control channel monitoring adaptation.

In some example embodiments, the second device 120 may transmit, to the first device 110, an indication at least one cell associated with an identifier of the scheduling request, and the second device 120 may determine the cell based on the identifier of the scheduling request.

In some example embodiments, the second device 120 may determine at least one of a primary cell for a master cell group or a primary secondary cell for a secondary cell group to transmit the grant.

In some example embodiments, dual connectivity may be enabled, and the second device 120 may determine a cell in a cell group to which the cell where the scheduling request is transmitted belongs.

In some example embodiments, the physical downlink control channel monitoring adaptation may comprise at least one of search space set group switching or physical downlink control channel skipping.

Those skilled in the art can understand that all operations and features as described above with reference to FIGS. 1-2 are likewise applicable to the method 400 and have similar effects.

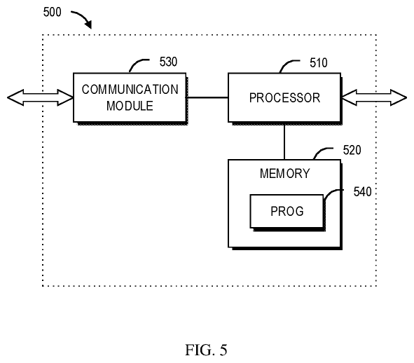

FIG. 5 is a simplified block diagram of a device 500 that is suitable for implementing example embodiments of the present disclosure. The device 500 can be implemented at or as a part of the first device 110 or the second device 120 as shown in FIG. 1.

As shown, the device 500 includes a processor 510, a memory 520 coupled to the processor 510, a communication module 530 coupled to the processor 510, and a communication interface (not shown) coupled to the communication module 530. The memory 520 stores at least a program 540. The communication module 530 is for bidirectional communications, for example, via multiple antennas. The communication interface may represent any interface that is necessary for communication.

The program 540 is assumed to include program instructions that, when executed by the associated processor 510, enable the device 500 to operate in accordance with the example embodiments of the present disclosure, as discussed herein with reference to FIGS. 1-4. The example embodiments herein may be implemented by computer software executable by the processor 510 of the device 500, or by hardware, or by a combination of software and hardware. The processor 510 may be configured to implement various example embodiments of the present disclosure.

The memory 520 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 520 is shown in the device 500, there may be several physically distinct memory modules in the device 500. The processor 510 may be of any type suitable to the local technical network, and may include one or more of general purpose computers, special purpose computers, microprocessors, digital signal processors (DSPs) and processors based on multicore processor architecture, as non-limiting examples. The device 500 may have multiple processors, such as an application specific integrated circuit chip that is slaved in time to a clock which synchronizes the main processor.

When the device 500 acts as the first device 110 or a part of the device 110, the processor 510 and the communication module 530 may cooperate to implement the method 300 as described above with reference to FIGS. 1-2. When the device 500 acts as the second device 120 or a part of the second device 120, the processor 510 and the communication module 530 may cooperate to implement the method 400 as described above with reference to FIGS. 1-2. All operations and features as described above with reference to FIGS. 1-4 are likewise applicable to the device 500 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 300 or 400 as described above with reference to FIG. 1. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device, determining, during a physical downlink control channel monitoring adaptation, to transmit a scheduling request to a second device; transmitting the scheduling request to the second device; determining one or more cells on which the physical downlink control channel monitoring is to be performed; and performing the physical downlink control channel monitoring on the one or more cells.

In some example embodiments, the determining to transmit the scheduling request to the second device comprises: in response to a buffer status report to be transmitted to the second device, determining to transmit, to the second device, the scheduling request for the buffer status report.

In some example embodiments, one logical channel is associated with an identifier of the scheduling request, and the determining one or more cells comprises: determining, based on the identifier of the scheduling request, the one or more cells in an allowed cell list associated with the one logical channel.

In some example embodiments, the determined the one or more cells in the allowed cell list comprise at least one of: a cell with a lowest cell index in the allowed cell list; a cell with a highest cell index in the allowed cell list; or all cells in the allowed cell list.

In some example embodiments, one logical channel is associated with an identifier of the scheduling request, and the method further comprising: receiving, from the second device information of at least one cell index; and the determining the one or more cells comprises determining at least one cell with the at least one cell index in an allowed cell list associated with the one logical channel.

In some example embodiments, a plurality of logical channels are associated with an identifier of the scheduling request, and the determining one or more cells comprises: determining, based on the identifier of the scheduling request, one or more cells in a plurality of allowed cell lists associated with the plurality of logical channels.

In some example embodiments, the determined the one or more cells in the plurality of allowed cell lists comprise at least one of: a cell with a lowest cell index in the plurality of allowed cell lists; a cell with a highest cell index in the plurality of allowed cell lists; or all cells in the plurality of allowed cell lists.

In some example embodiments, the determining to transmit the scheduling request to the second device comprises: in response to occurrence of beam failure recovery, determining to transmit the scheduling request to the second device.

In some example embodiments, the determining to transmit the scheduling request to the second device comprises: in response to a failure of a listen before talk procedure, determining to transmit the scheduling request.

In some example embodiments, the method further comprises: receiving, from the second device, an indication of at least one cell associated with an identifier of the scheduling request, and determining the one or more cells comprises: determining the one or more cells of the at least one cell on which the physical downlink control channel monitoring is to be performed based on the identifier of the scheduling request and the association.

In some example embodiments, the determining one or more cells comprises at least one of: determining a primary cell for a master cell group or determining a primary secondary cell for a secondary cell group.

In some example embodiments, dual connectivity is enabled, and the determining one or more cells comprises: determining all of one or more cells in a cell group to which the cell where the scheduling request is transmitted belongs.

In some example embodiments, the physical downlink control channel monitoring adaptation comprises at least one of search space set group switching or physical downlink control channel skipping.

In some aspects, a method comprises: at a second device, receiving, from a first device, a scheduling request during a physical downlink control channel monitoring adaptation for the first device; determining a cell to transmit, to the first device, a grant for the scheduling request; and transmitting the grant on the cell to the first device, regardless the physical downlink control channel monitoring adaptation.

In some example embodiments, the receiving the scheduling request during the physical downlink control channel monitoring adaptation comprises: receiving a scheduling request for a buffer status report during the physical downlink control channel monitoring adaptation.

In some example embodiments, one logical channel is associated with an identifier of the scheduling request, and determining the cell to transmit the grant for the scheduling request comprises: determining, based on the identifier of the scheduling request, a cell in an allowed cell list associated with the one logical channel to transmit the grant.

In some example embodiments, the determined cell in the allowed cell list comprises one of: a cell with a lowest cell index in the allowed cell list; or a cell with a highest cell index in the allowed cell list.

In some example embodiments, one logical channel is associated with an identifier of the scheduling request, and the method further comprises transmitting, to the first device, information of at least one cell index; and the determining a cell comprises: determining a cell of at least one cell with the at least one cell index in an allowed cell list associated with the one logical channel.

In some example embodiments, a plurality of logical channels are associated with an identifier of the scheduling request, and the determining a cell to transmit a grant for the scheduling request comprises: determining, based on the identifier of the scheduling request, a cell in a plurality of allowed cell lists associated with the plurality of logical channels to transmit the grant.

In some example embodiments, the determined cell in the plurality of allowed cell lists comprises one of: a cell with a lowest cell index in the plurality of allowed cell lists; or a cell with a highest cell index in the plurality of allowed cell lists.

In some example embodiments, the receiving a scheduling request during the physical downlink control channel monitoring adaptation comprises: receiving the scheduling request for beam failure recovery during the physical downlink control channel monitoring adaptation.

In some example embodiments, the receiving a scheduling request during the physical downlink control channel monitoring adaptation comprises: receiving the scheduling request for a failure of a listen before talk procedure during the physical downlink control channel monitoring adaptation.

In some example embodiments, the method further comprises: transmitting, to the first device, an indication at least one cell associated with an identifier of the scheduling request, and determining the cell to transmit the grant for the scheduling request comprises: determining the cell based on the identifier of the scheduling request and the association.

In some example embodiments, determining the cell to transmit the grant for the scheduling request comprises at least one of: determining a primary cell for a master cell group to transmit the grant or determining a primary secondary cell for a secondary cell group to transmit the grant.

In some example embodiments, dual connectivity is enabled, and determining the cell to transmit the grant for the scheduling request comprises: determining a cell in a cell group to which the cell where the scheduling request is transmitted belongs.

In some example embodiments, the physical downlink control channel monitoring adaptation comprises at least one of search space set group switching or physical downlink control channel skipping.

In some aspects, a first device comprises: at least one processor; and at least one memory including computer program code; the at least one memory and the computer program code configured to, with the at least one processor, cause the first device to: determine during a physical downlink control channel monitoring adaptation, to transmit a scheduling request to a second device; transmit the scheduling request to the second device; determine one or more cells on which the physical downlink control channel monitoring is to be performed; and perform the physical downlink control channel monitoring on the one or more cells.

In some example embodiments, the determining to transmit the scheduling request to the second device comprises: in response to a buffer status report to be transmitted to the second device, determining to transmit, to the second device, the scheduling request for the buffer status report.

In some example embodiments, one logical channel is associated with an identifier of the scheduling request, and the determining one or more cells comprises: determining, based on the identifier of the scheduling request, the one or more cells in an allowed cell list associated with the one logical channel.

In some example embodiments, the determined the one or more cells in the allowed cell list comprise at least one of: a cell with a lowest cell index in the allowed cell list; a cell with a highest cell index in the allowed cell list; or all cells in the allowed cell list.

In some example embodiments, one logical channel is associated with an identifier of the scheduling request, and the at least one memory and the computer program code configured to, with the at least one processor, cause the first device to: receive, from the second device information of at least one cell index; and the determining the one or more cells comprises: determining at least one cell with the at least one cell index in an allowed cell list associated with the one logical channel.

In some example embodiments, a plurality of logical channels are associated with an identifier of the scheduling request, and the determining one or more cells comprises: determining, based on the identifier of the scheduling request, one or more cells in a plurality of allowed cell lists associated with the plurality of logical channels.

In some example embodiments, the determined the one or more cells in the plurality of allowed cell lists comprise at least one of: a cell with a lowest cell index in the plurality of allowed cell lists; a cell with a highest cell index in the plurality of allowed cell lists; or all cells in the plurality of allowed cell lists.

In some example embodiments, the determining to transmit the scheduling request to the second device comprises: in response to occurrence of beam failure recovery, determining to transmit the scheduling request to the second device.

In some example embodiments, the determining to transmit the scheduling request to the second device comprises: in response to a failure of a listen before talk procedure, determining to transmit the scheduling request.

In some example embodiments, the at least one memory and the computer program code configured to, with the at least one processor, cause the first device to: receive, from the second device, an indication of at least one cell associated with an identifier of the scheduling request, and the determining the one or more cells comprises: determining the one or more cells of the at least one cell on which the physical downlink control channel monitoring is to be performed based on the identifier of the scheduling request and the association.

In some example embodiments, determining one or more cells comprises at least one of: determining a primary cell for a master cell group or determining a primary secondary cell for a secondary cell group.

In some example embodiments, dual connectivity is enabled, and the determining one or more cells comprises: determining all of one or more cells in a cell group to which the cell where the scheduling request is transmitted belongs.

In some example embodiments, the physical downlink control channel monitoring adaptation comprises at least one of search space set group switching or physical downlink control channel skipping.

In some aspects, a second device comprises: at least one processor; and at least one memory including computer program code; the at least one memory and the computer program code configured to, with the at least one processor, cause the second device to: receive, from a first device, a scheduling request during a physical downlink control channel monitoring adaptation for the first device; determine a cell to transmit, to the first device, a grant for the scheduling request; and transmit the grant on the cell to the first device, regardless the physical downlink control channel monitoring adaptation.

In some example embodiments, the receiving the scheduling request during the physical downlink control channel monitoring adaptation comprises: receiving a scheduling request for a buffer status report during the physical downlink control channel monitoring adaptation.

In some example embodiments, one logical channel is associated with an identifier of the scheduling request, and the determining the cell to transmit the grant for the scheduling request comprises: determining, based on the identifier of the scheduling request, a cell in an allowed cell list associated with the one logical channel to transmit the grant.

In some example embodiments, the determined cell in the allowed cell list comprises one of: a cell with a lowest cell index in the allowed cell list; or a cell with a highest cell index in the allowed cell list.

In some example embodiments, one logical channel is associated with an identifier of the scheduling request, and the at least one memory and the computer program code configured to, with the at least one processor, cause the second device to: transmit, to the first device, information of at least one cell index; and wherein the determining a cell comprises: determining a cell of at least one cell with the at least one cell index in an allowed cell list associated with the one logical channel.

In some example embodiments, a plurality of logical channels are associated with an identifier of the scheduling request, and the determining a cell to transmit a grant for the scheduling request comprises: determining, based on the identifier of the scheduling request, a cell in a plurality of allowed cell lists associated with the plurality of logical channels to transmit the grant.

In some example embodiments, the determined cell in the plurality of allowed cell lists comprises one of: a cell with a lowest cell index in the plurality of allowed cell lists; or a cell with a highest cell index in the plurality of allowed cell lists.

In some example embodiments, the receiving a scheduling request during the physical downlink control channel monitoring adaptation comprises: receiving the scheduling request for beam failure recovery during the physical downlink control channel monitoring adaptation.

In some example embodiments, the receiving a scheduling request during the physical downlink control channel monitoring adaptation comprises: receiving the scheduling request for a failure of a listen before talk procedure during the physical downlink control channel monitoring adaptation.

In some example embodiments, the at least one memory and the computer program code configured to, with the at least one processor, cause the second device to: transmit, to the first device, an indication of at least one cell associated with an identifier of scheduling request, and the determining a cell to transmit a grant for the scheduling request comprises: determining the cell based on the identifier of the scheduling request and the association.

In some example embodiments, the determining a cell to transmit a grant for the scheduling request comprises at least one of: determining a primary cell for a master cell group to transmit the grant, or determining a primary secondary cell for a secondary cell group to transmit the grant.

In some example embodiments, dual connectivity is enabled, and the determining a cell to transmit a grant for the scheduling request comprises: determining a cell in a cell group to which the cell where the scheduling request is transmitted belongs.

In some example embodiments, the physical downlink control channel monitoring adaptation comprises at least one of search space set group switching, or physical downlink control channel skipping.

In some aspects, a first device comprises: means for determining, during a physical downlink control channel monitoring adaptation, to transmit a scheduling request to a second device; means for transmitting the scheduling request to the second device; means for determining one or more cells on which the physical downlink control channel monitoring is to be performed; and means for performing the physical downlink control channel monitoring on the one or more cells.

In some example embodiments, the means for determining to transmit the scheduling request to the second device comprises: means for, in response to a buffer status report to be transmitted to the second device, determining to transmit, to the second device, the scheduling request for the buffer status report.

In some example embodiments, one logical channel is associated with an identifier of the scheduling request, and the means for determining one or more cells comprises: means for determining, based on the identifier of the scheduling request, the one or more cells in an allowed cell list associated with the one logical channel.

In some example embodiments, the determined the one or more cells in the allowed cell list comprise at least one of: a cell with a lowest cell index in the allowed cell list; a cell with a highest cell index in the allowed cell list; or all cells in the allowed cell list.

In some example embodiments, one logical channel is associated with an identifier of the scheduling request, and the first device further comprises: means for receiving, from the second device information of at least one cell index; and the means for determining the one or more cells comprises: means for determining at least one cell with the at least one cell index in an allowed cell list associated with the one logical channel.

In some example embodiments, a plurality of logical channels are associated with an identifier of the scheduling request, and the means for determining one or more cells comprises: means for determining, based on the identifier of the scheduling request, one or more cells in a plurality of allowed cell lists associated with the plurality of logical channels.

In some example embodiments, the determined the one or more cells in the plurality of allowed cell lists comprise at least one of: a cell with a lowest cell index in the plurality of allowed cell lists; a cell with a highest cell index in the plurality of allowed cell lists; or all cells in the plurality of allowed cell lists.

In some example embodiments, the means for determining to transmit the scheduling request to the second device comprises: means for, in response to occurrence of beam failure recovery, determining to transmit the scheduling request to the second device.

In some example embodiments, the means for determining to transmit the scheduling request to the second device comprises: means for, in response to a failure of a listen before talk procedure, determining to transmit the scheduling request.

In some example embodiments, the method further comprises: means for receiving, from the second device, an indication of at least one cell associated with an identifier of the scheduling request, and means for determining the one or more cells comprises: determining the one or more cells of the at least one cell on which the physical downlink control channel monitoring is to be performed based on the identifier of the scheduling request and the association.

In some example embodiments, the means for determining one or more cells comprises: means for determining a primary cell for a master cell group or means for determining a primary secondary cell for a secondary cell group.

In some example embodiments, dual connectivity is enabled, and the means for determining one or more cells comprises: means for determining all of one or more cells in a cell group to which the cell where the scheduling request is transmitted belongs.

In some example embodiments, the physical downlink control channel monitoring adaptation comprises at least one of search space set group switching or physical downlink control channel skipping.

In some aspects, a second device comprises: means for receiving, from a first device, a scheduling request during a physical downlink control channel monitoring adaptation for the first device; means for determining a cell to transmit, to the first device, a grant for the scheduling request; and means for transmitting the grant on the cell to the first device, regardless the physical downlink control channel monitoring adaptation.

In some example embodiments, the means for receiving the scheduling request during the physical downlink control channel monitoring adaptation comprises: means for receiving a scheduling request for a buffer status report during the physical downlink control channel monitoring adaptation.

In some example embodiments, one logical channel is associated with an identifier of the scheduling request, and the means for determining the cell to transmit the grant for the scheduling request comprises: means for determining, based on the identifier of the scheduling request, a cell in an allowed cell list associated with the one logical channel to transmit the grant.

In some example embodiments, the determined cell in the allowed cell list comprises one of: a cell with a lowest cell index in the allowed cell list; or a cell with a highest cell index in the allowed cell list.

In some example embodiments, one logical channel is associated with an identifier of the scheduling request, and the second device further comprises: means for transmitting, to the first device, information of at least one cell index; and the means for determining a cell comprises: means for determining a cell of at least one cell with the at least one cell index in an allowed cell list associated with the one logical channel.

In some example embodiments, a plurality of logical channels are associated with an identifier of the scheduling request, and the means for determining a cell to transmit a grant for the scheduling request comprises: means for determining, based on the identifier of the scheduling request, a cell in a plurality of allowed cell lists associated with the plurality of logical channels to transmit the grant.

In some example embodiments, the determined cell in the plurality of allowed cell lists comprises one of: a cell with a lowest cell index in the plurality of allowed cell lists; or a cell with a highest cell index in the plurality of allowed cell lists.

In some example embodiments, the means for receiving a scheduling request during the physical downlink control channel monitoring adaptation comprises: means for receiving the scheduling request for beam failure recovery during the physical downlink control channel monitoring adaptation.

In some example embodiments, the means for receiving a scheduling request during the physical downlink control channel monitoring adaptation comprises: means for receiving the scheduling request for a failure of a listen before talk procedure during the physical downlink control channel monitoring adaptation.

In some example embodiments, the method further comprises: means for transmitting, to the first device, an indication at least one cell associated with an identifier of the scheduling request, and means for determining the cell to transmit the grant for the scheduling request comprises: determining the cell based on the identifier of the scheduling request and the association.

In some example embodiments, the means for determining the cell to transmit the grant for the scheduling request comprises: means for determining a primary cell to transmit the grant or means for determining a primary secondary cell for a secondary cell group.

In some example embodiments, dual connectivity is enabled, and the means for determining the cell to transmit the grant for the scheduling request comprises: means for determining a cell in a cell group to which the cell where the scheduling request is transmitted belongs.

In some example embodiments, the physical downlink control channel monitoring adaptation comprises at least one of search space set group switching or physical downlink control channel skipping.

In some aspects, a computer readable storage medium comprises program instructions stored thereon, the instructions, when executed by a processor of a device, causing the device to perform the method according to some example embodiments of the present disclosure.

I/We claim:

1. A method comprising:
at a first device,
determining, during a physical downlink control channel monitoring adaptation, to transmit a scheduling request to a second device;
transmitting the scheduling request to the second device;
determining one or more cells on which the physical downlink control channel monitoring is to be performed; and
performing the physical downlink control channel monitoring on the one or more cells.

2. The method of claim 1, wherein the determining to transmit a scheduling request to the second device comprises:
in response to a buffer status report to be transmitted to the second device, determining to transmit, to the second device, the scheduling request for the buffer status report.

3. The method of claim 1 or claim 2, wherein one logical channel is associated with an identifier of the scheduling request, and wherein the determining one or more cells comprises:
determining, based on the identifier of the scheduling request, the one or more cells in an allowed cell list associated with the one logical channel.

4. The method of claim 3, wherein the determined one or more cells in the allowed cell list comprise at least one of:
a cell with a lowest cell index in the allowed cell list;
a cell with a highest cell index in the allowed cell list; or
all cells in the allowed cell list.

5. The method of claim 1 or 2, wherein one logical channel is associated with an identifier of the scheduling request, and the method further comprising:
receiving, from the second device, information of at least one cell index; and
wherein the determining one or more cells comprises:
determining at least one cell with the at least one cell index in an allowed cell list associated with the one logical channel.

6. The method of claim 1 or claim 2, wherein a plurality of logical channels are associated with an identifier of the scheduling request, and wherein the determining one or more cells comprises:
determining, based on the identifier of the scheduling request, one or more cells in a plurality of allowed cell lists associated with the plurality of logical channels.

7. The method of claim 6, wherein the determined the one or more cells in the plurality of allowed cell lists comprise at least one of:
a cell with a lowest cell index in the plurality of allowed cell lists;
a cell with a highest cell index in the plurality of allowed cell lists; or
all cells in the plurality of allowed cell lists.

8. The method of claim 1, wherein the determining to transmit the scheduling request to the second device comprises:
in response to occurrence of beam failure recovery, determining to transmit the scheduling request to the second device.

9. The method of claim 1, wherein the determining to transmit the scheduling request to the second device comprises:
in response to a failure of a listen before talk procedure, determining to transmit the scheduling request.

10. The method of any of claims 1-2 and 8-9, further comprising:
receiving, from the second device, an indication of at least one cell associated with an identifier of scheduling request, and wherein
the determining one or more cells comprises:
determining the one or more cells of the at least one cell on which the physical downlink control channel monitoring is to be performed based on the identifier of the scheduling request and the association.

11. The method of any of claims 1-2 and 8-9, wherein the determining one or more cells comprises at least one of:
determining a primary cell for a master cell group, or
determining a primary secondary cell for a secondary cell group.

12. The method of any of claims 1-2 and 8-9, wherein dual connectivity is enabled, and wherein the determining one or more cells comprises:
determining all of one or more cells in a cell group to which the cell where the scheduling request is transmitted belongs.

13. The method of any of claims 1-12, wherein the physical downlink control channel monitoring adaptation comprises at least one of search space set group switching, or physical downlink control channel skipping.

14. A method comprising:
at a second device,
receiving, from a first device, a scheduling request during a physical downlink control channel monitoring adaptation for the first device;
determining a cell to transmit, to the first device, a grant for the scheduling request; and
transmitting the grant on the cell to the first device, regardless the physical downlink control channel monitoring adaptation.

15. The method of claim 14, wherein the receiving a scheduling request during the physical downlink control channel monitoring adaptation comprises:
receiving a scheduling request for a buffer status report during the physical downlink control channel monitoring adaptation.

16. The method of claim 14 or 15, wherein one logical channel is associated with an identifier of the scheduling request, and wherein determining the cell to transmit the grant for the scheduling request comprises:
determining, based on the identifier of the scheduling request, a cell in an allowed cell list associated with the one logical channel to transmit the grant.

17. The method of claim 16, wherein the determined cell in the allowed cell list comprises one of:
a cell with a lowest cell index in the allowed cell list; or
a cell with a highest cell index in the allowed cell list.

18. The method of claim 14 or 15, wherein one logical channel is associated with an identifier of the scheduling request, and the method further comprising:
transmitting, to the first device, information of at least one cell index; and wherein the determining a cell comprises:
determining a cell of at least one cell with the at least one cell index in an allowed cell list associated with the one logical channel associated with the identifier of the scheduling request.

19. The method of claim 14 or 15, wherein a plurality of logical channels are associated with an identifier of the scheduling request, and wherein the determining a cell to transmit a grant for the scheduling request comprises:
determining, based on the identifier of the scheduling request, a cell in a plurality of allowed cell lists associated with the plurality of logical channels to transmit the grant.

20. The method of claim 19, wherein the determined cell in the plurality of allowed cell lists comprises one of:
a cell with a lowest cell index in the plurality of allowed cell lists; or
a cell with a highest cell index in the plurality of allowed cell lists.

21. The method of claim 14, wherein the receiving a scheduling request during the physical downlink control channel monitoring adaptation comprises:
receiving the scheduling request for beam failure recovery during the physical downlink control channel monitoring adaptation.

22. The method of claim 14, wherein the receiving a scheduling request during the physical downlink control channel monitoring adaptation comprises:
receiving the scheduling request for a failure of a listen before talk procedure during the physical downlink control channel monitoring adaptation.

23. The method of claim any of claims 14-15 and 21-22, further comprising:
transmitting, to the first device, an indication of at least one cell associated with an identifier of scheduling request, and wherein
the determining a cell to transmit a grant for the scheduling request comprises:
determining the cell based on the identifier of the scheduling request and the association.

24. The method of any of claims 14-15 and 21-22, wherein the determining a cell to transmit a grant for the scheduling request comprises at least one of:
determining a primary cell for a master cell group to transmit the grant, or
determining a primary secondary cell for a secondary cell group to transmit the grant.

25. The method of any of claims 14-15 and 21-22, wherein dual connectivity is enabled, and wherein the determining a cell to transmit a grant for the scheduling request comprises:
determining a cell in a cell group to which the cell where the scheduling request is transmitted belongs.

26. The method of any of claims 14-25, wherein the physical downlink control channel monitoring adaptation comprises at least one of search space set group switching, or physical downlink control channel skipping.

27. A first device, comprising:
at least one processor; and
at least one memory including computer program code;
the at least one memory and the computer program code configured to, with the at least one processor, cause the first device to:
determine, during a physical downlink control channel monitoring adaptation, to transmit a scheduling request to a second device;
transmit the scheduling request to the second device;
determine one or more cells on which the physical downlink control channel monitoring is to be performed; and
perform the physical downlink control channel monitoring on the one or more cells.

28. The first device of claim 27, wherein the determining to transmit the scheduling request to the second device comprises:
in response to a buffer status report to be transmitted to the second device, determining to transmit, to the second device, the scheduling request for the buffer status report.

29. The first device of claim 27 or claim 28, wherein one logical channel is associated with an identifier of the scheduling request, and wherein the determining one or more cells comprises:
determining, based on the identifier of the scheduling request, the one or more cells in an allowed cell list associated with the one logical channel.

30. The first device of claim 29, wherein the determined one or more cells in the allowed cell list comprise at least one of:
a cell with a lowest cell index in the allowed cell list;
a cell with a highest cell index in the allowed cell list; or
all cells in the allowed cell list.

31. The first device of claim 27 or 28, wherein one logical channel is associated with an identifier of the scheduling request, and wherein the at least one memory and the computer program code configured to, with the at least one processor, cause the first device to:
receive, from the second device, information of at least one cell index; and
wherein the determining one or more cells comprises:
determining at least one cell with the at least one cell index in an allowed cell list associated with the one logical channel.

32. The first device of claim 27 or claim 28, wherein a plurality of logical channels are associated with an identifier of the scheduling request, and wherein the determining one or more cells comprising:
determining, based on the identifier of the scheduling request, one or more cells in a plurality of allowed cell lists associated with the plurality of logical channels.

33. The first device of claim 32, wherein the determined the one or more cells in the plurality of allowed cell lists comprise at least one of:
a cell with a lowest cell index in the plurality of allowed cell lists;
a cell with a highest cell index in the plurality of allowed cell lists; or
all cells in the plurality of allowed cell lists.

34. The first device of claim 27, wherein the determining to transmit the scheduling request to the second device comprises:
in response to occurrence of beam failure recovery, determining to transmit the scheduling request to the second device.

35. The first device of claim 27, wherein the determining to transmit the scheduling request to the second device comprises:
in response to a failure of a listen before talk procedure, determining to transmit the scheduling request.

36. The first device of any of claims 27-28 and 34-35, wherein the at least one memory and the computer program code configured to, with the at least one processor, cause the first device to:
receive, from the second device, an indication of at least one cell associated with an identifier of scheduling request, and wherein
the determining one or more cells comprises:
determining the one or more cells of the at least one cell on which the physical downlink control channel monitoring is to be performed based on the identifier of the scheduling request and the association.

37. The first device of any of claims 27-28 and 34-35, wherein the determining one or more cells comprises at least one of:
determining a primary cell for a master cell group, or
determining a primary secondary cell for a secondary cell group.

38. The first device of any of claims 27-28 and 34-35, wherein dual connectivity is enabled, and wherein the determining one or more cells comprises:
determining all of one or more cells in a cell group to which the cell where the scheduling request is transmitted belongs.

39. The first device of any of claims 27-38, wherein the physical downlink control channel monitoring adaptation comprises at least one of search space set group switching, or physical downlink control channel skipping.

40. A second device, comprising:
at least one processor; and
at least one memory including computer program code;
the at least one memory and the computer program code configured to, with the at least one processor, cause the second device to:
receive, from a first device, a scheduling request during a physical downlink control channel monitoring adaptation for the first device;
determine a cell to transmit, to the first device, a grant for the scheduling request; and
transmit the grant on the cell to the first device, regardless the physical downlink control channel monitoring adaptation.

41. The second device of claim 40, wherein the receiving a scheduling request during the physical downlink control channel monitoring adaptation comprises:
receiving a scheduling request for a buffer status report during the physical downlink control channel monitoring adaptation.

42. The second device of claim 40 or 41, wherein one logical channel is associated with an identifier of the scheduling request, and wherein the determining the cell to transmit the grant for the scheduling request comprises:
determining, based on the identifier of the scheduling request, a cell in an allowed cell list associated with the one logical channel to transmit the grant.

43. The second device of claim 42, wherein the determined cell in the allowed cell list comprises one of:
a cell with a lowest cell index in the allowed cell list; or
a cell with a highest cell index in the allowed cell list.

44. The second device of claim 40 or 41, wherein one logical channel is associated with an identifier of the scheduling request, and wherein the at least one memory and the computer program code configured to, with the at least one processor, cause the second device to:
transmit, to the first device, information of at least one cell index; and wherein the determining a cell comprises:
determining a cell of at least one cell with the at least one cell index in an allowed cell list associated with the one logical channel associated with the identifier of the scheduling request.

45. The second device of claim 40 or 41, wherein a plurality of logical channels are associated with an identifier of the scheduling request, and wherein the determining a cell to transmit a grant for the scheduling request comprises:
determining, based on the identifier of the scheduling request, a cell in a plurality of allowed cell lists associated with the plurality of logical channels to transmit the grant.

46. The second device of claim 45, wherein the determined cell in the plurality of allowed cell lists comprises one of:
a cell with a lowest cell index in the plurality of allowed cell lists; or
a cell with a highest cell index in the plurality of allowed cell lists.

47. The second device of claim 40, wherein the receiving a scheduling request during the physical downlink control channel monitoring adaptation comprises:
receiving the scheduling request for beam failure recovery during the physical downlink control channel monitoring adaptation.

48. The second device of claim 40, wherein the receiving a scheduling request during the physical downlink control channel monitoring adaptation comprises:
receiving the scheduling request for a failure of a listen before talk procedure during the physical downlink control channel monitoring adaptation.

49. The second device of claim any of claims 40-41 and 47-48, wherein the at least one memory and the computer program code configured to, with the at least one processor, cause the second device to:
transmit, to the first device, an indication of at least one cell associated with an identifier of scheduling request, and wherein
the determining a cell to transmit a grant for the scheduling request comprises:
determining the cell based on the identifier of the scheduling request and the association.

50. The second device of any of claims 40-41 and 47-48, wherein the determining a cell to transmit a grant for the scheduling request comprises at least one of:
determining a primary cell for a master cell group to transmit the grant, or
determining a primary secondary cell for a secondary cell group to transmit the grant.

51. The second device of any of claims 40-41 and 47-48, wherein dual connectivity is enabled, and wherein the determining a cell to transmit a grant for the scheduling request comprises:
determining a cell in a cell group to which the cell where the scheduling request is transmitted belongs.

52. The second device of any of claims 40-51, wherein the physical downlink control channel monitoring adaptation comprises at least one of search space set group switching, or physical downlink control channel skipping.

53. A first device, comprising means for performing:
determining, during a physical downlink control channel monitoring adaptation, to transmit a scheduling request to a second device;
transmitting the scheduling request to the second device;
determining one or more cells on which the physical downlink control channel monitoring is to be performed; and
performing the physical downlink control channel monitoring on the one or more cells.

54. A second device, comprising means for performing:
receiving, from a first device, a scheduling request during a physical downlink control channel monitoring adaptation for the first device;
determining a cell to transmit, to the first device, a grant for the scheduling request; and
transmitting the grant on the cell to the first device, regardless the physical downlink control channel monitoring adaptation.

55. A first device comprising means for performing a method of any of claims 1-13.

56. A second device comprising means for performing a method of any of claims 14-26.
